(19) United States
(12) Patent Application Publication
(10) Pub. No.: US 2017/0157697 A1
(43) Pub. Date: Jun. 8, 2017

(54) WELDING ELECTRODE FOR USE IN RESISTANCE SPOT WELDING WORKPIECE STACK-UPS THAT INCLUDE AN ALUMINUM WORKPIECE AND A STEEL WORKPIECE

(71) Applicant: GM GLOBAL TECHNOLOGY OPERATIONS LLC, Detroit, MI (US)

(72) Inventors: David S. Yang, Shanghai (CN); David R. Sigler, Shelby Township, MI (US)

(21) Appl. No.: 14/962,866

(22) Filed: Dec. 8, 2015

(51) Int. Cl. B23K 11/30; B23K 11/11; B23K 11/20

(52) U.S. Cl. CPC B23K 11/3009; B23K 11/20; B23K 11/115

(57) ABSTRACT

A welding electrode suitable for resistance spot welding applications includes a first portion, a second portion, and a reduced diameter portion that extends between and connects the first and second portions. The first portion includes a weld face and the second portion includes a mounting base that opens to an internal recess having a cooling pocket. The reduced diameter portion extends between a back surface of the first portion and a front surface of the second portion such that a gap separates the back and front surfaces from each other. The gap may be vacant or filled with a low conductivity material. The disclosed welding electrode may be used in conjunction with another welding electrode to resistance spot weld a workpiece stack-up that includes an aluminum workpiece and an adjacent overlapping steel workpiece.

### TECHNICAL FIELD

The technical field of this disclosure relates generally to resistance spot welding and, more particularly, to resistance spot welding an aluminum workpiece and an adjacent overlapping steel workpiece.

### BACKGROUND

Resistance spot welding is a process used by a number of industries to join together two or more metal workpieces. The automotive industry, for example, often uses resistance spot welding to join together metal workpieces during the manufacture of a vehicle door, hood, trunk lid, lift gate, and/or body structures such as body sides and cross-members, among others. A number of spot welds are often formed at various points around an edge of the metal workpieces or some other bonding region to ensure the part is structurally sound. While spot welding has typically been practiced to join together certain similarly composed metal workpieces—such as steel-to-steel and aluminum-to-aluminum—the desire to incorporate lighter weight materials into a vehicle body structure has generated interest in joining steel workpieces to aluminum workpieces by resistance spot welding. The aforementioned desire to resistance spot weld dissimilar metal workpieces is not unique to the automotive industry; indeed, it extends to other industries that may utilize spot welding as a joining process including the aviation, maritime, railway, and building construction industries.

Resistance spot welding, in general, relies on the flow of electrical current through overlapping metal workpieces to generate the heat needed for fusion welding. To carry out such a welding process, a set of opposed spot welding electrodes is clamped at aligned spots on opposite sides of the workpiece stack-up, which typically includes two or three metal workpieces arranged in lapped configuration, at a predetermined weld site. Electrical current is then passed through the metal workpieces from one welding electrode to the other. Resistance to the flow of this electrical current generates heat within the metal workpieces and at their faying interface(s). When the workpiece stack-up includes an aluminum workpiece and an adjacent overlapping steel workpiece, the heat generated at the faying interface and within the bulk material of those dissimilar metal workpieces initiates and grows a molten aluminum weld pool that extends into the aluminum workpiece from the faying interface. This molten aluminum weld pool wets the adjacent faying surface of the steel workpiece and, upon cessation of the current flow, solidifies into a weld joint that bonds the two workpieces together.

In practice, however, spot welding an aluminum workpiece to a steel workpiece is challenging since a number of characteristics of those two metals can adversely affect the strength—most notably the peel strength—of the weld joint. For one, the aluminum workpiece usually contains one or more mechanically tough, electrically insulating, and self-healing refractory oxide layers on its surface. The oxide layer(s) are typically comprised of aluminum oxides, but may include other metal oxide compounds as well, including magnesium oxides when the aluminum workpiece is composed of a magnesium-containing aluminum alloy. As a result of their physical properties, the refractory oxide layer(s) have a tendency to remain intact at the faying interface where they can hinder the ability of the molten aluminum weld pool to wet the steel workpiece and also provide a source of near-interface defects within the growing weld pool. The insulating nature of the surface oxide layer(s) also raises the electrical contact resistance of the aluminum workpiece—namely, at its faying surface and at its electrode contact point—making it difficult to effectively control and concentrate heat within the aluminum workpiece. Efforts have been made in the past to remove the oxide layer(s) from the aluminum workpiece prior to spot welding. Such removal practices can be impractical, though, since the oxide layer(s) have the ability to regenerate in the presence of oxygen, especially with the application of heat from spot welding operations.

In addition to the challenges presented by the one or more oxide layers contained on the aluminum workpiece surfaces, the aluminum workpiece and the steel workpiece also possess different properties that tend to complicate the spot welding process. Specifically, aluminum has a relatively low melting point (˜600° C.) and relatively low electrical and thermal resistivities, while steel has a relatively high melting point (˜1500° C.) and relatively high electrical and thermal resistivities. As a result of these physical differences, most of the heat is generated within the steel workpiece during current flow. This heat imbalance sets up a temperature gradient between the steel workpiece (higher temperature) and the aluminum workpiece (lower temperature) that initiates rapid melting of the aluminum workpiece. The combination of the temperature gradient created during current flow and the high thermal conductivity of the aluminum workpiece means that, immediately after the electrical current ceases, a situation occurs where heat is not disseminated symmetrically from the weld site. Instead, heat is conducted from the hotter steel workpiece through the aluminum workpiece towards the welding electrode on the other side of the aluminum workpiece, which creates a steep thermal gradient in that direction.

The development of a steep thermal gradient between the steel workpiece and the welding electrode on the other side of the aluminum workpiece is believed to weaken the integrity of the resultant weld joint in two primary ways. First, because the steel workpiece retains heat for a longer duration than the aluminum workpiece after the flow of electrical current has ceased, the molten aluminum weld pool solidifies directionally, starting from the region nearest the colder welding electrode (often water cooled) associated with the aluminum workpiece and propagating towards the faying interface. A solidification front of this kind tends to sweep or drive defects—such as gas porosity, shrinkage voids, micro-cracking, and surface oxide residue—towards and along the faying interface within the weld joint. Second, the sustained elevated temperature in the steel workpiece promotes the growth of brittle Fe—Al intermetallic compounds at and along the faying interface. Having a dispersion of weld defects together with excessive growth of Fe—Al intermetallic compounds along the faying interface tends to reduce the peel strength of the weld joint.

In light of the aforementioned challenges, previous efforts to spot weld an aluminum workpiece and a steel workpiece have employed a weld schedule that specifies higher currents, longer weld times, or both (as compared to spot welding steel-to-steel), in order to try and obtain a reasonable weld bond area. Such efforts have been largely unsuccessful in a manufacturing setting and have a tendency to damage the welding electrodes. Given that previous spot welding efforts have not been particularly successful, mechanical fasteners including self-piercing rivets and flow-drill screws have predominantly been used to fasten aluminum and steel workpieces together. Mechanical fasteners, however, take longer to put in place and have high consumable costs compared to spot welding. They also add weight to the vehicle body structure—weight that is avoided when joining is accomplished by way of spot welding—that offsets some of the weight savings attained through the use of an aluminum workpiece in the first place. Advancements in spot welding that would make it easier to join aluminum and steel workpieces would thus be a welcome addition to the art.

### SUMMARY OF THE DISCLOSURE

A welding electrode suitable for resistance spot welding applications is disclosed that includes a first portion, a second portion, and a reduced diameter portion that extends between and connects the first and second portions. The first portion includes a weld face and the second portion includes a mounting base that opens to an internal recess having a cooling pocket. The reduced diameter portion extends between a back surface of the first portion and a front surface of the second portion such that a gap separates peripheral edge sections of the back and front surfaces from each other. And, to help ensure that electrical current and heat are conducted between the first and second portions primarily through the reduced diameter portion, the gap may be vacant (i.e., an air gap) or filled with a low conductivity material having an electrical conductivity and a thermal conductivity that are less than an electrical conductivity and a thermal conductivity of each of the first, second, and reduced diameter portions of the welding electrode.

The welding electrode may be used in conjunction with another welding electrode to resistance spot weld a workpiece stack-up that includes at least an aluminum workpiece and an adjacent overlapping steel workpiece. The workpiece stack-up may also include an additional workpiece such as another aluminum workpiece or another steel workpiece so long as the two workpieces of the same base metal composition are disposed next to each other. During spot welding, the weld face of the first portion of the disclosed welding electrode is pressed against a first side of the workpiece stack-up proximate the aluminum workpiece that lies adjacent to the steel workpiece, and the other welding electrode is pressed against an opposed second side of the stack-up proximate the steel workpiece. Electrical current is then passed between the welding electrodes and through the workpiece stack-up to create a molten aluminum weld pool within the aluminum workpiece that lies adjacent to the steel workpiece. Passage of electrical current through the workpiece stack-up is eventually ceases, allowing the molten aluminum weld pool to solidify into a weld joint that bonds the adjacent aluminum and steel workpieces together.

The use of the disclosed welding electrode is believed to positively contribute to the strength—most notably the peel strength—of the weld joint formed between the adjacent and overlapping aluminum and steel workpieces. To be sure, upon cessation of electrical current flow, the heat that has been generated within the first portion of the welding electrode, as well as the heat that disseminates from the steel workpiece and the molten aluminum weld pool, is drawn towards the second portion of the welding electrode due to the high thermal conductivity of the aluminum workpiece. And since heat cannot, for the most part, traverse the gap that separates the back and front surfaces of the first and second portions of the welding electrode, it flows from the first portion to the second portion primarily through the reduced diameter portion by way of conduction. Channeling conductive heat flow through the reduced diameter portion in this way influences the solidification behavior of the molten aluminum weld pool as it transitions into the weld joint and results in weld defects being swept towards the center of the joint where they are less liable to adversely affect the strength of the joint.

### BRIEF DESCRIPTION OF THE DRAWINGS

FIG. 1 is a cross-sectional view of a welding electrode suitable for resistance spot welding operations according to one embodiment of the present disclosure;

FIG. 2 is a magnified cross-sectional view of a part of the welding electrode shown in FIG. 1;

FIG. 3 is a magnified cross-sectional view of one embodiment of a weld face configuration that may be employed with the welding electrode shown in FIG. 1;

FIG. 4 is a cross-sectional view of a welding electrode suitable for resistance spot welding operations according to another embodiment of the present disclosure;

FIG. 5 is a general cross-sectional view of a workpiece stack-up, which includes an aluminum workpiece and an adjacent steel workpiece assembled in overlapping fashion, situated between a welding electrode according to the present disclosure and another welding electrode in preparation for resistance spot welding;

FIG. 6 is a general cross-sectional view of a workpiece stack-up, which includes an aluminum workpiece and an adjacent steel workpiece assembled in overlapping fashion, situated between a welding electrode according to the present disclosure and another welding electrode in preparation for resistance spot welding, although here the workpiece stack-up includes an additional aluminum workpiece (i.e., two aluminum workpieces and one steel workpiece) according to one embodiment of the disclosure;

FIG. 7 is a general cross-sectional view of a workpiece stack-up, which includes an aluminum workpiece and an adjacent steel workpiece assembled in overlapping fashion, situated between a welding electrode according to the present disclosure and another welding electrode in preparation for resistance spot welding, although here the workpiece stack-up includes an additional steel workpiece (i.e., one aluminum workpiece and two steel workpieces) according to one embodiment of the disclosure;

FIG. 8 is a general perspective view of the welding electrode depicted in FIG. 5 that may be used in conjunction with the first welding electrode (e.g., the welding electrode depicted in FIG. 1) to resistance spot weld the workpiece stack-up;

FIG. 9 is a general cross-sectional view of the workpiece stack-up and welding electrodes shown in FIG. 5 during passage of electrical current between the welding electrodes and through the stack-up, wherein the passage of electrical current has caused melting of the aluminum workpiece that lies adjacent to the steel workpiece and the creation of a molten aluminum weld pool within the aluminum workpiece;

FIG. 10 is a general cross-sectional view of the workpiece stack-up and welding electrodes shown in FIG. 5 after passage of the electrical current between the welding electrodes and through the stack-up has ceased so as to allow the molten aluminum weld pool to solidify into a weld joint that bonds the adjacent aluminum and steel workpieces together;

FIG. 11 illustrates the direction of the solidification front in a molten aluminum weld pool that solidifies from the point nearest the colder welding electrode located proximate the aluminum workpiece towards the faying interface as is common in conventional spot welding practices; and

FIG. 12 illustrates the direction of the solidification front in a molten aluminum weld pool that solidifies from its outer perimeter towards it center as a result of using the welding electrode of the present disclosure.

### DETAILED DESCRIPTION

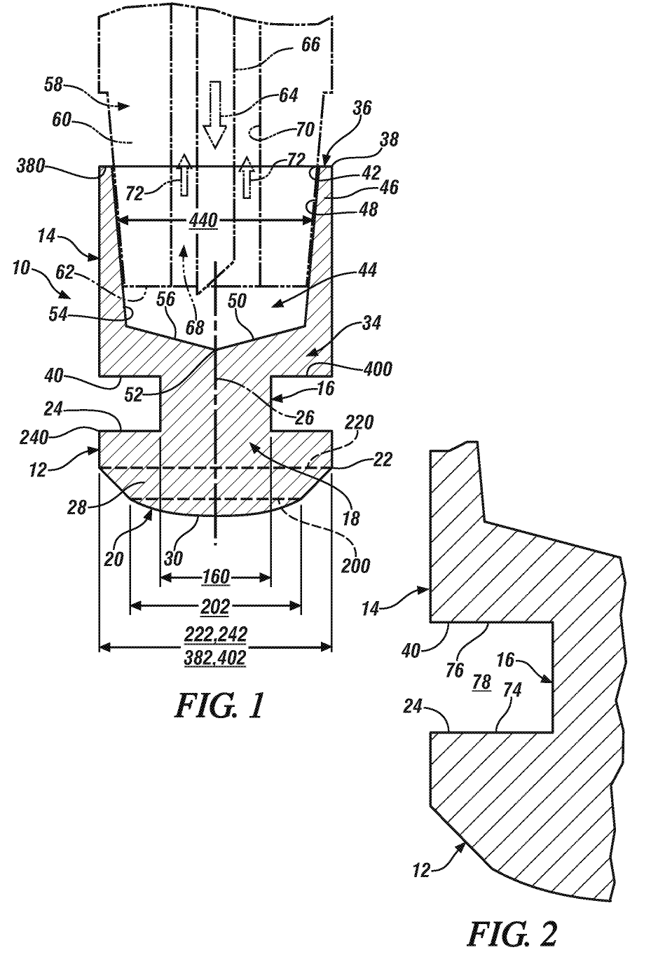

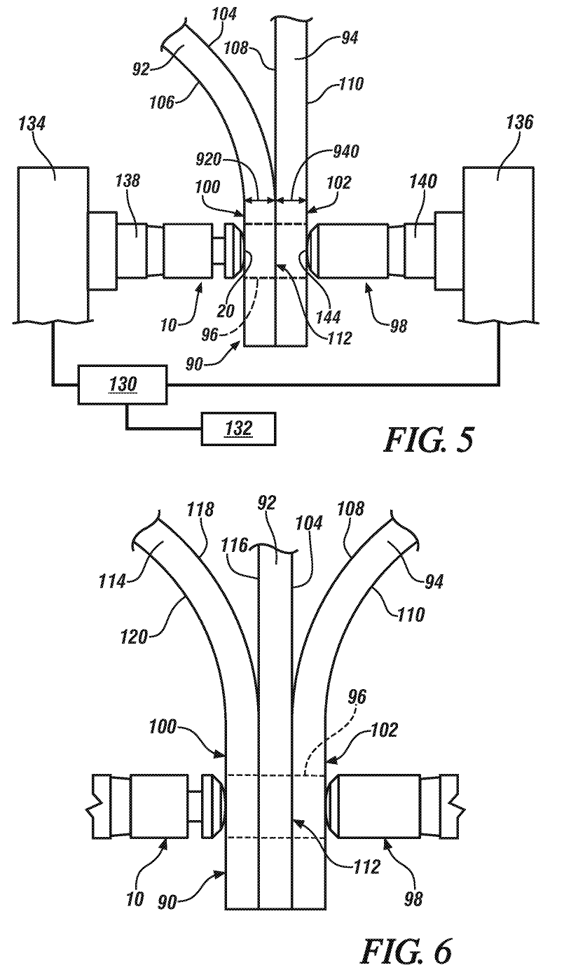

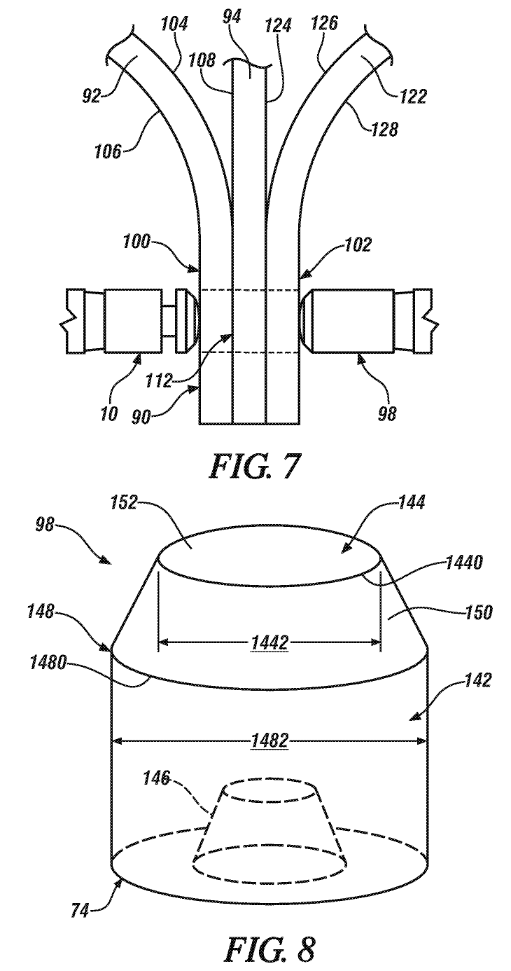

A welding electrode that is useful in resistance spot welding applications is represented by reference numeral 10 in FIGS. 1-11. In particular, the welding electrode 10 may be used to spot weld a workpiece stack-up that includes at least an aluminum workpiece and an overlapping and adjacent steel workpiece, as will be described in more detail below with reference to FIGS. 5-12. For example, the welding electrode 10 is operable to spot weld a “2T” workpiece stack-up (FIG. 5) that includes only the adjacent and overlapping pair of aluminum and steel workpieces. Other workpiece stack-up configurations are of course amenable to spot welding in a similar way. Indeed, the welding electrode 10 is also operable to spot weld a “3T” workpiece stack-up (FIGS. 6-7) that includes the adjacent and overlapping pair of aluminum and steel workpieces plus an additional aluminum workpiece or an additional steel workpiece so long as the two workpieces of the same base metal composition, i.e., aluminum or steel, are disposed next to each other (aluminum-aluminum-steel or aluminum-steel-steel) within the stack-up.

Referring now to FIG. 1, the welding electrode 10 includes a first portion 12, a second portion 14, and a reduced diameter portion 16 that extends between and connects the first and second portions 12, 14. These portions 12, 14, 16 of the welding electrode 10 may be integrally formed in the sense that they constitute a single formed article of manufacture and cannot be in indestructibly detached from one another. In other embodiments, however, the portions 12, 14, 16 of the welding electrode 10 are not integrally formed but, rather, some or all of the portions 12, 14, 16 are distinct components that are attached by way of interference fit, laser welding, or some other attachment mechanism suitable for attaching separately manufactured items. Moreover, in order to adequately conduct electrical current and heat during resistance spot welding applications, each of the first portion 12, the second portion 14, and the reduced diameter portion 16 is constructed form a material having an electrical conductivity of between 45% and 100% IACS (100% IACS being equal to 5.80×10⁷ S/m), and preferably between 80% and 95% IACS, and a thermal conductivity of at least 180 W/mK.

The first portion 12 of the welding electrode 10 includes a body 18 and a weld face 20. The body 18 includes a front end 22 and a back surface 24 opposite the front end 22, and is preferably cylindrical in shape. The front end 22 has a circumference 220 with a diameter 222 and, likewise, the back surface 24 has a circumference 240 with a diameter 242. Each of the diameters 222, 242 of the front end 22 and the back surface 24 preferably lie within the range of 12 mm to 22 mm or, more narrowly, within the range of 16 mm to 20 mm. The diameters 222, 242 of the front end 22 and the back surface 24 (and thus their associated circumferences 220, 240) are the same in this embodiment as a result of the cylindrical shape of the body 18. In other embodiments, however, such as when the body 18 is not cylindrically-shaped, the diameters 222, 242 of the front end 22 and the back surface 24 may be different.

The weld face 20 is disposed on the front end 22 of the body 18 and is the portion of the welding electrode 10 that contacts a side of a workpiece stack-up under pressure during spot welding. The weld face 20 has a circumference 200 with a diameter 202 and is centered on an axis 26 (also referred to in this disclosure as the “weld face axis”). The diameter 202 of the weld face 20 preferably lies within the range of 6 mm to 20 mm or, more narrowly, within the range of 8 mm to 12 mm. Regarding the relative position of weld face 20, a number of ways exist for disposing the weld face 20 on the front end 22 of the body 18. For example, the weld face 20 may transition directly from the front end 22 such that the circumference 200 of the weld face 20 is coincident with the circumference 220 of the front end 22 of the body 18 (termed a “full face electrode”). As another example, the weld face 20 may be upwardly displaced from the front end 22 of the body 18 by a transition nose 28 preferably of frusto-conical or truncated spherical shape. If a transition nose 28 is present, the circumferences 220, 200 of the front end 22 of the body 18 and the weld face 20 may be parallel as shown here in FIG. 1, or they may be angled such that the circumference 200 of the weld face 20 is tilted relative to the circumference 220 of the front end 22.

A broad range of electrode weld face designs may be implemented for the welding electrode 10. The weld face 20, for example, includes a base weld face surface 30 that may be nominally planar or spherically domed. If spherically domed, the base weld face surface 30 ascends from the circumference 200 of the weld face 20 with a truncated spherical profile having a radius of curvature that preferably lies within the range of 15 mm to 300 mm or, more narrowly, within the range of 20 mm to 50 mm. Moreover, regardless of whether it is nominally planar or spherically domed, the base weld face surface 30 may be smooth or roughened. The weld face 20 may also include a central projection such as a raised plateau or spherical ball-nose projection about its axis 26. Still further, the weld face 20 may include a series of upstanding concentric rings of ridges that project outwardly from the base weld face surface 30 such as the ridges disclosed in U.S. Pat. Nos. 8,222,560; 8,436,269; 8,927,894; or in U.S. Pat. Pub. 2013/0200048.

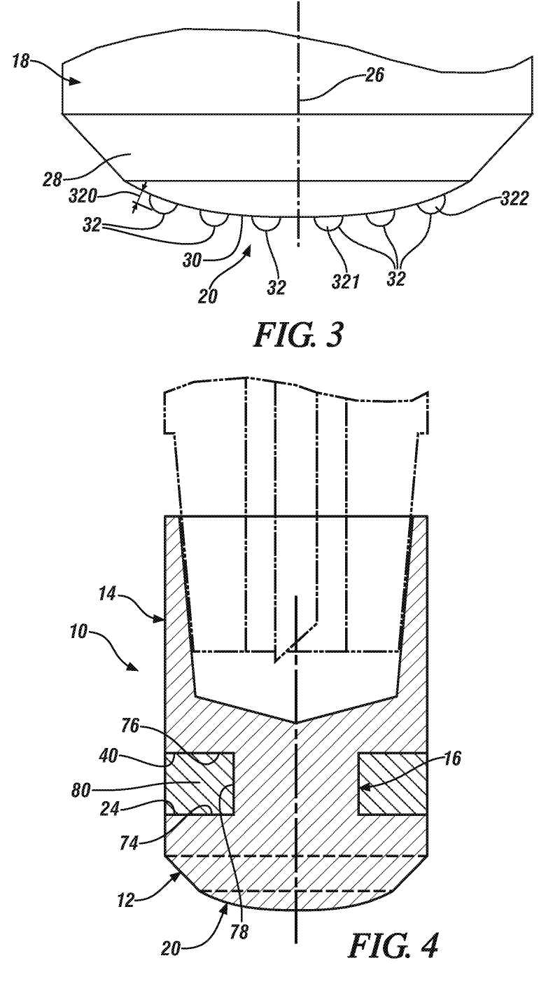

In a preferred embodiment of the welding electrode 10, the weld face 20 includes a plurality of upstanding circular ridges 32 that are centered about and surround the axis 26 of the weld face 20, as shown in FIG. 3. The base weld face surface 30 accounts for 50% or more, and preferably between 50% and 80%, of the surface area of the weld face 20. The remaining surface area of the weld face 20 is attributed to the plurality of upstanding circular ridges 32, which preferably includes anywhere from two to ten ridges 32, or more narrowly from three to five ridges 32. The several upstanding ridges 32 are radially spaced apart from each other on the base weld face surface 30 such that the upstanding ridges 32 become larger in diameter when moving from the innermost upstanding ridge 321 that immediately surrounds the axis 26 of the weld face 20 to the outermost upstanding ridge 322 that is most proximate to the circumference 200 of the weld face 20.

The size and shape of the upstanding circular ridges 32 are designed to improve mechanical stability and reduce the electrical and thermal contact resistance at the electrode/workpiece junction while at the same time being easily redressable. In one embodiment, as shown, each of the upstanding circular ridges 32 has a closed circumference, meaning the circumference of the ridge 32 is not interrupted by significant separations, with a cross-sectional profile that lacks sharp corners and has a curved (as shown in FIG. 3) or flat top surface. Each of the circular ridges 32 also has a ridge height 320—taken at the midpoint of the ridge 32—that extends upwards and is positively displaced from the base weld face surface 30 when viewed in cross-section. The ridge height 320 of each ridge 32 preferably ranges from 20 μm to 400 μm or, more narrowly, from 50 μm to 300 μm. And the spacing of the ridges 32 measured between the center of the ridges 32 preferably ranges from 50 μm to 1800 μm or, more narrowly, from 80 μm to 1500 μm.

The second portion 14 of the welding electrode 10 includes a body 34 having a mounting base 36 at a back end 38 and a front surface 40 opposite the back end 38. And, like the body 18 of the first portion 12, the body 34 of the second portion 14 is preferably cylindrical in shape. The back end 38 has a circumference 380 with a diameter 382 and, likewise, the front surface 40 has a circumference 400 with a diameter 402. Each of the diameters 382, 402 of the back end 38 and the front surface 40 preferably lie within the range of 12 mm to 22 mm or, more narrowly, within the range of 16 mm to 20 mm. The diameters 382, 402 of the back end 38 and the front surface 40 (and thus their associated circumferences 380, 400) are the same in this embodiment as a result of the cylindrical shape of the body 34. In other embodiments, however, such as when the body 34 is not cylindrically-shaped, the diameters 382, 402 of the back end 38 and the front surface 40 may be different.

The mounting base 36 at the back end 38 of the second portion 14 supports mounting of the welding electrode 10 to a weld gun. In a preferred embodiment, as shown best in FIG. 1, the mounting base 36 defines an opening 42 to an accessible internal recess 44 that is surrounded by a peripheral outer wall 46 of the body 34. The opening 42 has a diameter 420 that preferably lies within the range of 10 mm to 20 mm or, more narrowly, in the range of 14 mm to 18 mm. The internal recess 44 is defined by one or more interior side walls 48 that extend from the opening 42 to one or more bottom walls 50 that establish a depth 52 of the recess 44. The one or more interior side walls 48 provide the internal recess 44 with a diameter 440 within the body 34 that may be constant or variable as the side walls 48 extend towards the depth 52 of the recess 44. For example, as shown here in FIG. 1, the one or more interior side walls 48 taper inwards such that the diameter 440 of the internal recess 44 at the transition of the one or more side walls 48 and the one or more bottom walls 50 is anywhere from 1% to 3% less than the diameter 420 of the opening 42.

A part of the internal recess 44 proximate the front surface 40 of the body 34 of the second portion 14 serves as a cooling pocket 54 for the welding electrode 10. The cooling pocket 54 receives a flow cooling fluid—typically water—during spot welding operations to extract heat away from the weld face 20. The ability to extract heat away from the weld face 20 helps counteract degradation mechanisms (e.g., contamination buildup and plastic deformation) that may occur at the weld face 20 during spot welding and, as a result, can preserve the workable lifetime of the welding electrode 10 and reduce the need to redress the weld face 20. The cooling pocket 54 shown here in FIG. 1 is bound by the one or more bottom walls 50 and a section of the one or more interior side walls 48 extending part of the way from the bottom wall(s) 50 to the opening 42 of the internal recess 44. The one or more bottom walls 50 in this embodiment, moreover, taper inward from the one or more side walls 48 down to the depth 52 of the internal recess 44 to define a conical cup 56. The conical cup 56 constitutes the region of the cooling pocket 54 closest to the front surface 40 of the body 34.

To mount the welding electrode 10 onto a weld gun, the mounting base 36 of the second portion 14 can be secured to a shank adapter 58 (shown in phantom in FIG. 1) carried by a weld gun arm. The shank adapter 58, a shown, includes an outer shell 60 having an inward taper that matches the inward taper of the one or more interior side walls 48 of the internal recess 44. The complimentary fitting nature of the outer shell 60 and the internal recess 44 allows the outer shell 60 to be received through the opening 42 and to frictionally engage the one or more interior side walls 48. The outer shell 60 and the one or more interior side walls 48 are forcibly slid in opposite directions relative to one another to advance a front end 62 of the outer shell 60 into the internal recess 44 and towards its depth 52. Such forced frictional advancement of the outer shell 60 establishes an interference fit that prevents both axial and rotational movement between the shank adapter 58 and the internal recess 44 during spot welding applications. Of course, other techniques for securing the shank adapter 58 within the internal recess 44 may be used in addition to or in lieu or an interference fit described above.

The cooling pocket 54, as discussed above, is bound by the one or more bottom walls 50 and the section of the one or more interior side walls 48 that extend part of the way from the bottom wall(s) 50 to the opening 42 of the internal recess 44. The cooling pocket 54 is also bound transversely across the internal recess 44 by the front end 62 of the shank adapter 58 once the shank adapter 58 is inserted into the internal recess 44 and secured to the mounting base 36. In this way, a flow 64 of cooling fluid can be introduced into the cooling pocket 54 through a cooling fluid supply tube 66 located within an internal bore 68 defined by the outer shell 60 of the shank adapter 58. An annular space 70 of the internal bore 68 that fluidly communicates with the cooling pocket 54 and surrounds the cooling fluid supply tube 66 functions as a water return channel; that is, as the flow 64 of cooling fluid enters the cooling pocket 54, a cooling fluid outflow 72 is forced out of the cooling pocket 54 and into the water return channel where it (along with any acquired heat) is carried away from the welding electrode 10.

The reduced diameter portion 16 extends between the back surface 24 of the first portion 12 and the front surface 40 of the second portion 14 to connect the first and second portions 12, 14 together. The reduced diameter portion 16 has a diameter 160 that is less than each of the diameters 242, 402 of the back surface 24 of the first portion 12 and the front surface 400 of the second portion 14, respectively, and preferably extends between a center of the back surface 24 and a center of the front surface 40. A peripheral edge section 74 of the back surface 24 of the first portion 12 and a peripheral edge section 76 of the front surface 40 of the second portion 14 are thus separated from each other by a gap 78. And, to help ensure that electrical current and heat are conducted between the first and second portions 12, 14 primarily through the reduced diameter portion 16, the gap 78 may be vacant (i.e., an air gap) or filled with a low conductivity material 80 (FIG. 4) having an electrical conductivity and a thermal conductivity that are less than the electrical conductivity and the thermal conductivity of each of the first, second, and reduced diameter portions 12, 14, 16 of the welding electrode 10. Additionally, to best affect weld pool solidification, as will be described in more detail below, the diameter 160 of the reduced diameter portion 16 is chosen to provide the reduced diameter portion 16 with a cross-sectional area of less than 80%, and preferably less than 50%, of the larger of the cross-sectional area of the back surface 24 and the cross-sectional area of the front surface 40.

The reduced diameter portion 16 may assume a variety of configurations that, consequently, may influence the shape and symmetry of the gap 78 between the peripheral edge sections 74, 76 of the back and front surfaces 24, 40. In a preferred embodiment, as shown in FIG. 1, the reduced diameter portion 16 is cylindrical in shape and extends longitudinally along the weld face axis 26 between the centers of the back and front surfaces 24, 40. When the reduced diameter portion 16 is configured in this way, the back and front surfaces 24, 40 of the first and second portions 12, 14 are facially aligned, which means the peripheral edge section 74 of the back surface 24 and the peripheral edge section 76 of the front surface 40 are spaced apart along the weld face axis 26 and the gap 78 that separates them is an annular gap. The peripheral edge sections 74, 76 may be spaced apart along the weld face axis 26 by a distance that preferably ranges from 0.1 mm to 10 mm or, more narrowly, from 1 mm to 5 mm. The diameters 242, 402 of the back and front surfaces 24, 40 may also be equal to one another and the corresponding circumferences 240, 400 of those surfaces 24, 40 may be diametrically aligned, as shown.

The first portion 12, the second portion 14, and the reduced diameter portion 16 may be constructed of a variety of materials that have an electrical conductivity of at least 45% IACS and a thermal conductivity of at least 180 W/mK. Some material classes that fit this criterion include a copper alloy and a refractory-based material that includes at least 35 wt %, and preferably at least 50 wt %, of an elemental refractory metal. Specific examples of suitable materials include a copper-zirconium alloy, a copper-chromium alloy, a copper-chromium-zirconium alloy, and a refractory-based metal composite that includes a molybdenum or tungsten particulate phase. A few specific and preferred materials include a zirconium-copper alloy (ZrCu) that contains 0.10 wt % to 0.20 wt % zirconium and the balance copper, and a tungsten-copper metal composite that contains between 50 wt % and 90 wt % of a tungsten particulate phase dispersed in copper matrix that constitutes the balance (between 50 wt % and 10 wt %). Other materials not expressly listed here that meet the applicable electrical and thermal conductivity standards may, of course, also be used as well.

Referring now to FIG. 4, an embodiment of the welding electrode 10 is shown in which the gap 78 the separates the peripheral edge section 74 of the back surface 24 of the first portion 12 and the peripheral edge section 76 of the front surface 40 of the second portion 14 is filled with the low conductivity material 80. As previously stated, both the electrical conductivity and the thermal conductivity of the low conductivity material 80 are less than the electrical conductivity and the thermal conductivity of each of the first, second, and reduced diameter portions 12, 14, 16 of the welding electrode 10. This helps ensure that heat and electrical current are conducted between the first and second portions 12, 14 of the welding electrode 10 primarily through the reduced diameter portion 16. A multitude of materials can be used as the low conductivity material 80. Some notable examples include low electrical/thermal conductivity metals and alloys such as low carbon steels, tool steel, stainless steels, cupronickel metals, Hastelloy® metals, Inconel® metals, titanium. Other suitable examples include electrical insulators such as alumina, fused silica, cordierite, porcelains, and polytetrafluoroethylene (e.g., Teflon®).

Referring now to FIGS. 5-12, the welding electrode 10 may be used to resistance spot weld a workpiece stack-up 90 that comprises at least an aluminum workpiece 92 and a steel workpiece 94 that overlap and lie adjacent to one another at a weld site 96. Indeed, as will be described in greater detail below, the disclosed spot welding method is broadly applicable to a wide variety of workpiece stack-up configurations that include the adjacent pair of aluminum and steel workpieces 92, 94. The workpiece stack-up 90 may, for example, include only the aluminum workpiece 92 and the steel workpiece 94, or it may include an additional aluminum workpiece (aluminum-aluminum-steel) or an additional steel workpiece (aluminum-steel-steel) so long as the two workpieces of the same base metal composition, i.e., aluminum or steel, are disposed next to each other in the stack-up 90. The steel and aluminum workpieces 92, 94 may be worked or deformed before or after being assembled into the workpiece stack-up 90 depending on the part being manufactured and the specifics of the overall manufacturing process for that particular part.

The workpiece stack-up 90 is illustrated in FIG. 5 along with the welding electrode 10 described above (hereafter referred to as the “first welding electrode” for purposes of identification) and a second welding electrode 98 that are mechanically and electrically configured on a weld gun (partially shown). The workpiece stack-up 90 has a first side 100 and a second side 102 that are accessible by the set of welding electrodes 10, 98 at the weld site 96. Here, in this embodiment, in which the workpiece stack-up 90 includes only the two workpieces 92, 94, the aluminum workpiece 92 provides the first side 100 of the stack-up 90 and the steel workpiece 94 provides the second side 102. Embodiments in which the workpiece stack-up 90 includes an additional third workpiece (either aluminum or steel) are described below in connection with FIGS. 6-7. And while only one weld site 96 is depicted in the Figures, skilled artisans will appreciate that spot welding may be practiced according to the disclosed method at multiple different weld sites on the same stack-up 90.

The aluminum workpiece 92 includes an aluminum substrate that is either coated or uncoated (i.e., bare). The aluminum substrate may be composed of elemental aluminum or an aluminum alloy that includes at least 85 wt. % aluminum. Some notable aluminum alloys that may constitute the coated or uncoated aluminum substrate are an aluminum-magnesium alloy, an aluminum-silicon alloy, an aluminum-magnesium-silicon alloy, or an aluminum-zinc alloy. If coated, the aluminum substrate preferably includes a surface layer of its natural refractory oxide layer(s), or, alternatively, it may include a surface layer of zinc, tin, or a metal oxide conversion coating comprised of oxides of titanium, zirconium, chromium, or silicon, as described in US2014/0360986. Taking into account the thickness of the aluminum substrate and any optional coating that may be present, the aluminum workpiece 92 has a thickness 920 that ranges from 0.3 mm to about 6.0 mm, or more narrowly from 0.5 mm to 3.0 mm, at least at the weld site 96.

The aluminum substrate of the aluminum workpiece 92 may be provided in wrought or cast form. For example, the aluminum substrate may be composed of a 4xxx, 5xxx, 6xxx, or 7xxx series wrought aluminum alloy sheet layer, extrusion, forging, or other worked article. Alternatively, the aluminum substrate may be composed of a 4xx.x, 5xx.x, 6xx.x, or 7xx.x series aluminum alloy casting. Some more specific kinds of aluminum alloys that may constitute the aluminum substrate include, but are not limited to, AA5754 aluminum-magnesium alloy, AA6022 aluminum-magnesium-silicon alloy, AA7003 aluminum-zinc alloy, and Al-10Si-Mg aluminum die casting alloy. The aluminum substrate may further be employed in a variety of tempers including annealed (O), strain hardened (H), and solution heat treated (T), if desired. The term “aluminum workpiece” thus encompasses elemental aluminum and a wide variety of aluminum alloy substrates, whether coated or uncoated, in different spot-weldable forms including wrought sheet layers, extrusions, forgings, etc., as well as castings, and further includes those that have undergone pre-welding treatments such as annealing, strain hardening, and solution heat treating.

The steel workpiece 94 includes a steel substrate that may be coated or uncoated (i.e., bare). The coated or uncoated steel substrate may be hot-rolled or cold-rolled and may be composed of any of a wide variety of steels including mild steel, interstitial-free steel, bake-hardenable steel, high-strength low-alloy (HSLA) steel, dual-phase (DP) steel, complex-phase (CP) steel, martensitic (MART) steel, transformation induced plasticity (TRIP) steel, twining induced plasticity (TWIP) steel, and press-hardened steel (PHS). And, if coated, the steel substrate preferably includes a surface layer of zinc, zinc-iron (galvanneal), a zinc-nickel alloy, nickel, aluminum, or an aluminum-silicon alloy. The term “steel workpiece” thus encompasses a wide variety of steel substrates, whether coated or uncoated, of different grades and strengths, and further includes those that have undergone pre-welding treatments like annealing, quenching, and/or tempering such as in the production of press-hardened steel. Taking into account the thickness of the steel substrate and any optional coating that may be present, the steel workpiece 94 has a thickness 940 that ranges from 0.3 mm and 6.0 mm, or more narrowly from 0.6 mm to 2.5 mm, at least at the weld site 96.

When the two workpieces 92, 94 are stacked-up for spot welding in the context of the current embodiment, the aluminum workpiece 92 includes a faying surface 104 and an exterior outer surface 106 and, likewise, the steel workpiece 94 includes a faying surface 108 and an exterior outer surface 110, as shown best in FIG. 5. The faying surfaces 104, 108 of the two workpieces 92, 94 overlap and contact one another to establish a faying interface 112 that extends through the weld site 96. The exterior outer surfaces 106, 110 of the aluminum and steel workpieces 92, 94, on the other hand, generally face away from one another in opposite directions at the weld site 96 and constitute the first and second sides 100, 102 of the workpiece stack-up 90. The distance between the respective faying 104, 108 and exterior outer surfaces 106, 110 of the aluminum and steel workpieces 92, 94 defines the thickness 920, 940 for each of those workpieces 92, 94.

The term “faying interface 112” is used broadly in the present disclosure and is intended to encompass instances of direct and indirect contact between the faying surfaces 104, 108 of the workpieces 92, 94. The faying surfaces 104, 108 are in direct contact with each other when they physically abut and are not separated by a discrete intervening material layer. The faying surfaces 104, 108 are in indirect contact with each other when they are separated by a discrete intervening material layer—and thus do not experience the type of interfacial physical abutment found in direct contact—yet are in close enough proximity to each other that resistance spot welding can still be practiced. Indirect contact between the faying surfaces 104, 108 of the aluminum and steel workpieces 92, 94 typically results when an optional intermediate material layer (not shown) is applied between the faying surfaces 104, 108 before the workpieces 92, 94 are superimposed against each other during formation of the workpiece stack-up 90.

An intermediate material layer that may be present between the faying surfaces 104, 108 of the aluminum and steel workpieces 92, 94 is an uncured yet heat-curable structural adhesive. Such an intermediate material typically has a thickness of 0.1 mm to 2.0 mm, which permits spot welding through the intermediate layer without much difficulty. A structural adhesive may be disposed between the faying surfaces 104, 108 of the aluminum and steel workpieces 92, 94 so that, following spot welding, the workpiece stack-up 90 can be heated in an ELPO-bake oven or other device to cure the adhesive and provide additional bonding between the workpieces 92, 94. A specific example of a suitable heat-curable structural adhesive is a heat-curable epoxy that may include filler particles, such as silica particles, to modify the viscosity or other mechanical properties of the adhesive when cured. A variety of heat-curable epoxies are commercially available including DOW Betamate 1486, Henkel 5089, and Uniseal 2343. Other types of materials may certainly constitute the intermediate material layer in lieu of a heat-curable structural adhesive.

Of course, as shown in FIGS. 6-7, the workpiece stack-up 90 is not limited to the inclusion of only the aluminum workpiece 92 and the adjacent steel workpiece 94. The workpiece stack-up 90 may also include an additional aluminum workpiece or an additional steel workpiece—in addition to the adjacent steel and aluminum alloy workpieces 92, 94—so long as the additional workpiece is disposed adjacent to the workpiece 92, 94 of the same base metal composition; that is, any additional aluminum workpiece is disposed adjacent to the aluminum workpiece 92 and any additional steel workpiece is disposed adjacent to the steel workpiece 94. As for the characteristics of the additional workpiece, the descriptions of the aluminum workpiece 92 and the steel workpiece 94 provided above are applicable to any additional steel or aluminum workpiece that may be included in the workpiece stack-up 90. It should be noted, though, that while the same general descriptions apply, there is no requirement that the two aluminum workpieces or the two steel workpieces of a three workpiece stack-up be identical in terms of composition, thickness, or form (e.g., wrought or cast).

As shown in FIG. 6, for example, the workpiece stack-up 90 may include the adjacent aluminum and steel workpieces 92, 94 described above along with an additional aluminum workpiece 114. Here, as shown, the additional aluminum workpiece 114 overlaps the adjacent aluminum and steel workpieces 92, 94 and is disposed adjacent to the aluminum workpiece 92. When the additional aluminum workpiece 114 is so positioned, the exterior outer surface 110 of the steel workpiece 94 provides and delineates the second side 102 of the workpiece stack-up 90, as before, while the aluminum workpiece 92 that lies adjacent to the steel workpiece 94 now includes a pair of opposed faying surfaces 104, 116. The faying surface 104 of the aluminum workpiece 92 that confronts and contacts (directly or indirectly) the adjacent faying surface 108 of the steel workpiece 94 establishes the faying interface 112 between the two workpieces 92, 94 as previously described. The other faying surface 116 of the aluminum workpiece 92 confronts and makes overlapping contact (direct or indirect) with a faying surface 118 of the additional aluminum workpiece 114. As such, in this particular arrangement of lapped workpieces 92, 94, 114, an exterior outer surface 120 of the additional aluminum workpiece 114 now provides and delineates the first side 100 of the workpiece stack-up 90.

In another example, as shown in FIG. 7, the workpiece stack-up 90 may include the adjacent aluminum and steel workpieces 92, 94 described above along with an additional steel workpiece 122. Here, as shown, the additional steel workpiece 122 overlaps the adjacent aluminum and steel workpieces 92, 94 and is disposed adjacent to the steel workpiece 94. When the additional steel workpiece 122 is so positioned, the exterior outer surface 106 of the aluminum workpiece 92 provides and delineates the first side 100 of the workpiece stack-up 90, as before, while the steel workpiece 94 that lies adjacent to the aluminum workpiece 92 now includes a pair of opposed faying surfaces 108, 124. The faying surface 108 of the steel workpiece 94 that confronts and contacts (directly or indirectly) the adjacent faying surface 104 of the aluminum workpiece 92 establishes the faying interface 112 between the two workpieces 92, 94 as previously described. The other faying surface 124 of the steel workpiece 94 confronts and makes overlapping contact (direct or indirect) with a faying surface 126 of the additional steel workpiece 122. As such, in this particular arrangement of lapped workpieces 92, 94, 122, an exterior outer surface 128 of the additional steel workpiece 122 now provides and delineates the second side 102 of the workpiece stack-up 90.

Returning now to FIG. 5, the first welding electrode 10 and the second welding electrode 98 are used to pass electrical current through the workpiece stack-up 90 and across the faying interface 112 of the adjacent aluminum and steel workpieces 92, 94 at the weld site 96 regardless of whether an additional workpiece 114, 122 is present. Each of the welding electrodes 10, 98 are carried by a weld gun (partially shown) of any conventional type including a C-type or an X-type weld gun. The spot welding operation may call for the weld gun to be mounted to a robot capable of moving the weld gun around the workpiece stack-up 90 as needed, or it may call for the weld gun to be configured as a stationary pedestal-type in which the workpiece stack-up 90 is manipulated and moved relative to the weld gun. Additionally, as illustrated schematically here, the weld gun may be associated with a power supply 130 that supplies the electrical current and a weld controller 132 that interfaces with the power supply 130 to control the characteristics of the electrical current in accordance with a programmed weld schedule. The weld gun may also be fitted with coolant lines and associated control equipment in order to deliver a coolant fluid, such as water, to each of the welding electrodes 10, 98.

The weld gun includes a first gun arm 134 and a second gun arm 136. The first gun arm 134 is fitted with a shank 138 that secures and retains the first welding electrode 10 and the second gun arm 136 is fitted with a shank 140 that secures and retains the second welding electrode 98. The secured retention of the welding electrodes 10, 98 on their respective shanks 138, 140 can be accomplished by way of shank adapters that are located at axial free ends of the shanks 138, 140 and received by the electrodes 10, 98 as shown and described with respect to FIG. 1. In terms of their positioning relative to the workpiece stack-up 90, the first welding electrode 10 is positioned to be brought into electrical communication with the first side 100 of the stack-up 90 proximate the aluminum workpiece 92, and, consequently, the second welding electrode 98 is positioned to be brought into electrical communication with the second side 102 of the stack-up 90 proximate the steel workpiece 94. The first and second weld gun arms 134, 136 are operable to converge or pinch the welding electrodes 10, 98 towards each other and to impose a clamping force on the workpiece stack-up 90 at the weld site 96 once the electrodes 10, 98 are brought into electrical communication with their respective workpiece stack-up sides 100, 102.

The second welding electrode 98 employed opposite the first welding electrode 10 can be any of a wide variety of electrode designs. Generally, as shown best in FIG. 8, the second welding electrode 98 includes an electrode body 142 and a weld face 144. The electrode body 142 is preferably cylindrical in shape and includes an accessible internal recess 146 (similar to the first welding electrode 10) for insertion of, and attachment with, a shank adapter (not shown) of the shank 140 associated with the second gun arm 136. A front end 148 of the electrode body 142 has a circumference 1480 with a diameter 1482 that lies within the range of 12 mm to 22 mm or, more narrowly, within the range of 16 mm to 20 mm. And, like before, the weld face 144 is disposed on the front end 148 of the body 142 and has a circumference 1440 that is coincident with the circumference 1480 of the front end 148 of the body 142 (a “full face electrode”) or is upwardly displaced from the circumference 1480 of the front end 148 by a transition nose 150. If a transition nose 150 is present, the two circumferences 1480, 1440 may be parallel as shown here in FIG. 1 or they may be offset such that the circumference 1440 of the weld face 144 is tilted relative to the circumference 1480 of the front end 148 of the body 142.

The weld face 144 is the portion of the second welding electrode 98 that establishes electrical communication with the second side 102 of the workpiece stack-up 90 proximate the steel workpiece 94. The weld face 144 preferably has a diameter 1442 measured at its circumference 1440 that lies within the range of 4 mm to 16 mm or, more narrowly, within the range of 8 mm to 12 mm. In terms of its profile, the weld face 144 includes a base weld face surface 152 that may be nominally planar or spherically domed. If spherically domed, the base weld face surface 152 ascends from the circumference 1440 of the weld face 144 with a truncated spherical profile having a radius of curvature that preferably lies within the range of 20 mm to 300 mm or, more narrowly, within the range of 20 mm to 150 mm. Additionally, the weld face 144 may include—but is not required to include—raised surface features such as a plateau surface that is positively displaced above the base weld face surface 152 about the center of the weld face 144, a rounded projection that rises above the base weld face surface 152 about the center of the weld face 144 (e.g., a ball-nose electrode), a plurality of upstanding circular ridges similar to those described above, or some other raised feature.

The second welding electrode 98 may be constructed from any electrically and thermally conductive material suitable for spot welding applications. For example, the second welding electrode 98 may be constructed from a copper alloy having an electrical conductivity of at least 80% IACS, or more preferably at least 90% IACS, and a thermal conductivity of at least 300 W/mK, or more preferably at least 350 W/mK. One specific example of a copper alloy that may be used for the second welding electrode 98 is a copper-zirconium alloy (CuZr) that contains about 0.10 wt. % to about 0.20 wt. % zirconium and the balance copper. Copper alloys that meet this constituent composition and are designated C15000 are generally preferred. Other copper alloy compositions, as well as other metal compositions not explicitly recited here, that possess suitable mechanical properties as well as electrical thermal conductivity properties may also be employed.

The resistance spot welding method will now be described with reference to FIGS. 5 and 9-12, which depict only the aluminum and steel workpieces 92, 94 that overlap and lie adjacent to one another so as to establish the faying interface 112. The presence of the additional aluminum or steel workpiece 114, 122 in the workpiece stack-up 90 does not affect how the spot welding method is carried out or have any substantial effect on the joining mechanism that takes place at the faying interface 112 of the adjacent aluminum and steel workpieces 92, 94. For that reason, when the spot welding method is described in further detail below, only the adjacent steel and aluminum workpieces 92, 94 are shown for the sake of simplicity. The more-detailed discussion provided below applies equally to instances in which the workpiece stack-up 90 includes the additional aluminum or steel workpiece 114, 122 (FIGS. 6 and 7) despite the fact that any such additional workpiece 114, 122 has been omitted from the Figures.

At the onset of the resistance spot welding method, which is depicted in FIG. 5, the workpiece stack-up 90 is located between the first welding electrode 10 and the opposed second welding electrode 98 with the first and second sides side 100, 102 positioned proximate the first and second welding electrodes 10, 98, respectively. The weld gun is then operated to converge the first and second welding electrodes 10, 98 relative to one another so that their respective weld faces 20, 144 are pressed against the opposite first and second sides 100, 102 of the stack-up 90 at the weld site 96. The weld faces 20, 144 are typically facially aligned with each other at the weld site 96 under a clamping force imposed on the workpiece stack-up 90. The imposed clamping force preferably ranges from 400 lb to 2000 lb or more narrowly from 600 lb to 1300 lb.

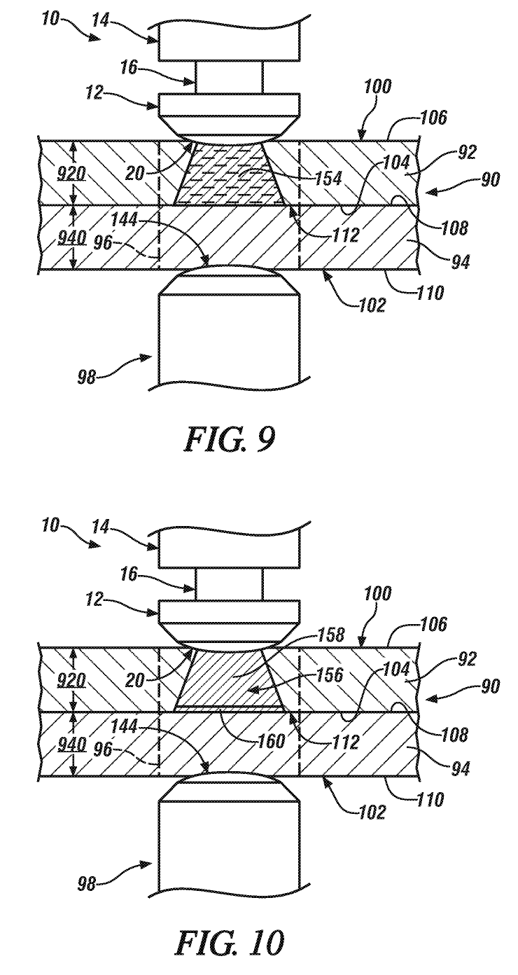

After the weld faces 20, 144 of first and second welding electrodes 10, 98 are in place and have established electrical communication with the first and second sides 100, 102 of the workpiece stack-up 90, respectively, electrical current is passed between the welding electrodes 10, 98 by way of their facially aligned weld faces 20, 144. The electrical current exchanged between the welding electrodes 10, 98 passes through the workpiece stack-up 90 and across the faying interface 112 established between the adjacent aluminum and steel workpieces 92, 94. Resistance to this flow of electrical current generates heat and initially heats up the more electrically and thermally resistive steel workpiece 94 quicker than the aluminum workpiece 92. The resistively generated heat eventually melts the aluminum workpiece 92 and creates a molten aluminum weld pool 154, as depicted in FIG. 9. The molten aluminum weld pool 154 wets the adjacent faying surface 108 of the steel workpiece 94 and extends into the aluminum workpiece 92 from the faying interface 112. The molten aluminum weld pool 154 may penetrate a distance into the aluminum workpiece 92 that ranges from 20% to 100% of the thickness 920 of the aluminum workpiece 92 at the weld site 96. And, in terms of its composition, the molten aluminum weld pool 154 is composed predominantly of aluminum material derived from the aluminum workpiece 92, as the steel workpiece 94 typically does not melt during electrical current flow, but can dissolve to some degree and introduce iron into the molten aluminum weld pool 154.

The electrical current passed between the first and second welding electrodes 10, 98 and through the workpiece stack-up 90 is preferably a DC (direct current) electrical current. A DC electrical current may be delivered by the power supply 130 which, as shown in FIG. 5, is placed in electrical communication with the first and second welding electrodes 10, 98. The power supply 130 is preferably a medium-frequency direct current (MFDC) inverter power supply that includes an inverter and a MFDC transformer, although other types of power supplies can certainly be used. The precise operation of the power supply 130 is governed by the weld controller 132. To be sure, the weld controller 132 controls the power supply 130 by dictating the manner in which DC electrical current is exchanged between the welding electrodes 10, 98 based on programmed instructions including a prescribed weld schedule. The programmed characteristics of the DC electrical current may command the DC electrical current to have a constant current level or be pulsed over time, or some combination of the two, and typically call for the current level to be maintained mostly between 5 kA and 50 kA from commencement to cessation and to last for a duration of 40 ms to 2,500 ms in order to create the molten aluminum weld pool 154 at the desired size.

After the passage of electrical current between the weld faces 20, 144 of the first and second welding electrodes 10, 98 ceases, the molten aluminum weld pool 154 solidifies into a weld joint 156 that bonds the aluminum workpiece 92 and the steel workpiece 94 together at the weld site 96, as illustrated in FIG. 10. The weld joint 156 includes an aluminum weld nugget 158 comprised of resolidified material of the aluminum workpiece 92, and may also include one or more reaction layers 160 of Fe—Al intermetallic compounds. The aluminum weld nugget 158 extends into the aluminum workpiece 92 to a distance that often ranges from 20% to 100% (100% being all the way through the aluminum workpiece 92) of the thickness 920 of the aluminum workpiece 92 at the weld site 96, just like the pre-existing molten aluminum weld pool 154. The one or more reaction layers 160 of Fe—Al intermetallic compounds, which are depicted here as a single idealized layer, are situated between the aluminum weld nugget 158 and the faying surface 108 of the steel workpiece 94. The Fe—Al intermetallic compounds are produced in layers at the faying interface 112 due to a reaction between the molten aluminum weld pool 154 and the steel workpiece 94 at spot welding temperatures. The one or more Fe—Al intermetallic layers 160 can include FeAl₃ compounds, Fe₂Al₅ compounds, and possibly other intermetallic compounds, and typically have a combined total thickness of 1 μm to 5 μm.

The weld joint 156 is expected to have enhanced strength—in particular enhanced peel strength—compared to weld joints formed according to conventional spot welding practices. The enhanced strength can be attributed to the structure of the first welding electrode 10 and its ability to minimize the unwanted dispersion of weld defects within the weld joint 156 at and along the faying interface 112. In particular, the structure of the first welding electrode 10 alters the solidification behavior of the molten aluminum weld pool 154 as it transitions into the weld joint 156 in a way that causes weld defects to be swept towards the center of the weld joint 156 and away from the outer edge of the joint 156. Directing weld defects towards the center of the weld joint 156 is believed to have a favorable impact on peel strength since the center of the weld joint 156 is a more innocuous location for weld defects to be present than at the outer edge of the joint 156 near the faying interface 112 and adjacent to the heat-affected zone that surrounds the weld joint 156.

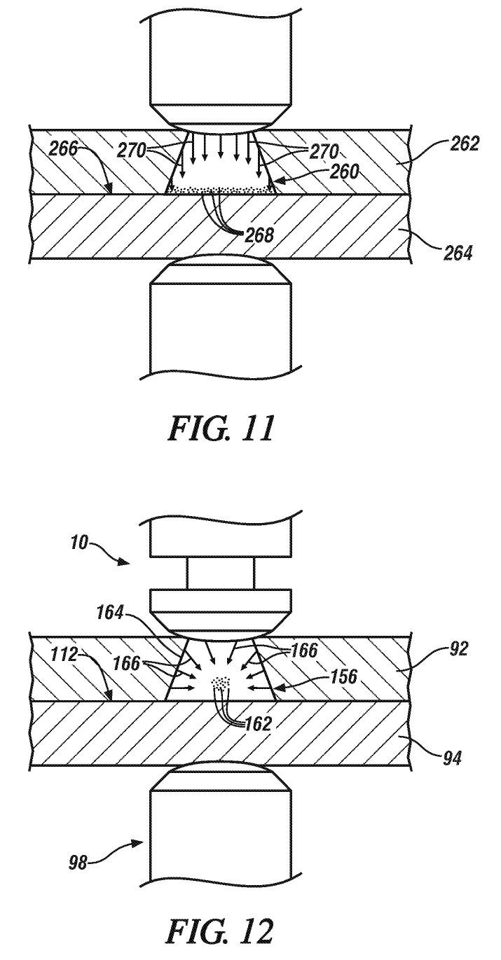

The influence that the structure of the first welding electrode 10 has on the solidification behavior of the molten aluminum weld pool 154 is represented generally in FIGS. 11-12. To provide some context, FIG. 11 depicts a weld joint 200 formed between an aluminum workpiece 202 and a steel workpiece 204 that overlap to establish a faying interface 206. The weld joint 200 illustrated here is representative of a weld joint formed by a conventional resistance spot welding process that does not use the first welding electrode 10 described above. As can be seen, weld defects 208 are dispersed at and along a faying interface 206 of the workpieces 202, 204 within the weld joint 200. These weld defects 208 may include shrinkage voids, gas porosity, surface oxide residue, and micro-cracking, among others. When present and distributed along the faying interface 206, the weld defects 208 may reduce the peel strength of the weld joint 200 and, more generally, may negatively impact and weaken the overall integrity of the joint 200.

Without being bound by theory, it is believed that the dispersion of the weld defects 208 at and along the faying interface 206 is due at least in part to the solidification behavior of the pre-existing molten aluminum alloy weld pool as it transforms into the weld joint 200. Specifically, a heat imbalance can develop between the much hotter steel workpiece 204 and the aluminum workpiece 202 because of the dissimilar physical properties of the two materials—namely, the much greater thermal and electrical resistivities of the steel. The steel workpiece 204 therefore acts as a heat source while the aluminum workpiece 202 acts as a heat conductor, creating a strong temperature gradient in the vertical direction that causes the molten aluminum weld pool to cool and solidify from the region proximate the cooler (e.g., water cooled) welding electrode proximate the aluminum workpiece 202 towards the faying interface 206. The path and direction of the solidification front is represented in FIG. 11 by arrows 210. As the solidification front progresses along path 210, the weld defects 208 are swept toward the faying interface 206 and eventually end up dispersed along the faying interface 206 within the weld join 206.

The structure of the first welding electrode 10 can avoid the solidification behavior shown in FIG. 11 and the proliferation of weld defects that results. Referring now to FIG. 12, a magnified illustration of the weld joint 156 formed according to the spot welding method described above is shown. As can be seen, weld defects 162 in this weld joint 156 are congregated near the center of the joint 156 as opposed to being more dispersed along the faying interface 112 as depicted in FIG. 11. The weld defects 162 are swept towards the center of the weld joint 156 because the structure of the first welding electrode 10 causes the molten aluminum weld pool 154 to solidify from its outer perimeter 164 towards its center. The path and direction of the solidification front is represented generally in FIG. 12 by arrows 166. The path 166, here, can sweep weld defects 162 into the center of the weld joint 156, either on or displaced from the faying interface 112, and can further consolidate the defects 162 into larger-sized defects.

The structure of the first welding electrode 10 induces the solidification front 166 shown in FIG. 12 by channeling heat flow through the reduced diameter portion 16. Specifically, the heat generated within the first portion 12 of the welding electrode 10 during spot welding, as well as heat that disseminates from the steel workpiece 94 and the molten aluminum weld pool 154, is drawn into the second portion 14 of the electrode 10 for extraction by the cooling fluid that flows through the cooling pocket 54. This heat is conducted to the second portion 14 primarily through the reduced diameter portion 16 since the air or the low conductivity material 80 contained in the gap 78 that separates the back surface 24 of the first portion 12 from the front surface 40 of the back portion 14 is much less capable of conducting heat. As such, upon cessation of electrical current flow through the workpiece stack-up 90, heat begins to flow to the center of the first portion 12 and up into the reduced diameter portion 16 towards the second portion 14. A temperature gradient is therefore established between the colder outer perimeter of the weld face 20 near its circumference 200 and the hotter center of the weld face 20. The established temperature gradient retains heat at the center of the molten aluminum weld pool 154, causing this region of the weld pool 154 to solidify last once electrical current flow ceases. As a result, weld defects such as shrinkage voids, gas voids, and oxide film residues are driven toward and retained at the center of the weld joint 156.

Returning back to FIG. 10, the first and second welding electrodes 10, 98 continue to exert the clamping force on the workpiece stack-up 90 until the molten aluminum weld pool 154 has fully solidified into the weld joint 156. Once the weld joint 156 is formed, the clamping force imposed on the workpiece stack-up 90 is diminished and the first and second welding electrodes 10, 98 are retracted away from their respective sides 100, 102 of the stack-up 90. The workpiece stack-up 90 may now be moved relative to the weld gun so that the first and second welding electrodes 10, 98 are positioned in facing alignment at another weld site 96 where the spot welding method is repeated. Or, rather than undergoing spot welding at a different site 96, the workpiece stack-up 52 may be moved away from the weld gun to make room for another similar workpiece stack-up 90. The spot welding method can thus be carried out many times at different weld sites 96 on the same or different workpiece stack-up in a manufacturing setting where spot weld cycle times and product throughput are metrics that command significant attention.

The above description of preferred exemplary embodiments and specific examples are merely descriptive in nature; they are not intended to limit the scope of the claims that follow. Each of the terms used in the appended claims should be given its ordinary and customary meaning unless specifically and unambiguously stated otherwise in the specification.

1. A welding electrode for use in spot welding operations, the welding electrode comprising:
a first portion that includes a weld face and a back surface opposite the weld face;
a second portion that includes a mounting base and a front surface opposite the mounting base, the mounting base defining an opening to an internal recess, a part of the internal recess serving as a cooling pocket; and
a reduced diameter portion extending between the back surface of the first portion and the front surface of the second portion, the reduced diameter portion connecting the first portion and the second portion such that a peripheral edge section of the back surface of the first portion and a peripheral edge section of the front surface of the second portion are separated from each other by an air gap or a low conductivity material having an electrical conductivity and a thermal conductivity that are less than an electrical conductivity and a thermal conductivity of each of the first portion, the second portion, and the reduced diameter portion.

2. The welding electrode set forth in claim 1, wherein the weld face is spherically domed and has a diameter that ranges from 6 mm to 20 mm and a radius of curvature that ranges from 15 mm to 300 mm.

3. The welding electrode set forth in claim 2, wherein the weld face includes a series of concentric circular ridges that project outwardly from a base surface of the weld face.

4. The welding electrode set forth in claim 1, wherein the peripheral edge section of the back surface of the first portion and the peripheral edge section of the front surface of the second portion are separated from each other by the low conductivity material, and wherein the low thermal conductivity material is an insulator.

5. The welding electrode set forth in claim 1, wherein the first portion, the second portion, and the reduced diameter portion are integrally connected.

6. The welding electrode set forth in claim 1, wherein the first portion, the second portion, and the reduced diameter portion are constructed from a copper-zirconium alloy, a copper-chromium alloy, a copper-chromium-zirconium alloy, or a tungsten-copper metal composite.

7. The welding electrode set forth in claim 1, wherein the reduced diameter portion extends longitudinally between the back surface of the first portion and the front surface of the second portion along an axis of the weld face, the peripheral edge section of the back surface of the first portion and the peripheral edge section of the front surface of the second portion defining an annular gap, the annular gap being vacant or filled with the low conductivity material having an electrical conductivity and a thermal conductivity that are less than an electrical conductivity and a thermal conductivity of each of the first, second, and reduced diameter portions.

8. The welding electrode set forth in claim 7, wherein the peripheral edge section of the back surface of the first portion and the peripheral edge section of the front surface of the second portion are spaced apart along the axis of the weld face by a distance that ranges from 0.1 mm to 10 mm.

9. The welding electrode set forth in claim 8, wherein a circumference of the back surface of the first portion is diametrically aligned with a circumference of the front surface of the second portion, and wherein each of a diameter of the back surface and a diameter of the front surface ranges in size from 12 mm to 22 mm.

10. A welding electrode for use in spot welding operations, the welding electrode comprising:
a first portion that includes a weld face and a back surface opposite the weld face;
a second portion that includes a mounting base and a front surface opposite the mounting base, the mounting base defining an opening to an internal recess, a part of the internal recess serving as a cooling pocket; and
a reduced diameter portion extending longitudinally between the back surface of the first portion and the front surface of the second portion along an axis of the weld face, the reduced diameter portion connecting the first portion and the second portion such that an annular gap is defined between a peripheral edge section of the back surface of the first portion and peripheral edge section of the front surface of the second portion, the annular gap being vacant or filled with a low conductivity material having an electrical conductivity and a thermal conductivity that are less than an electrical conductivity and a thermal conductivity of each of the first portion, the second portion, and the reduced diameter portion.

11. The welding electrode set forth in claim 10, wherein a circumference of the back surface of the first portion is diametrically aligned with a circumference of the front portion of the second portion, and wherein each of a diameter of the back surface and a diameter of the front surface ranges in size from 12 mm to 22 mm.

12. The welding electrode set forth in claim 11, wherein the back surface of the first portion and the front surface of the second portion are spaced apart along the axis of the weld face by a distance that ranges from 0.1 mm to 10 mm, and wherein the reduced diameter portion has a diameter such that a cross-sectional area of the reduced diameter portion is less than 80% of the larger of a cross-sectional area of the back surface of the front portion and a cross-sectional area of the front surface of the back portion.

13. The welding electrode set forth in claim 10, wherein the weld face is spherically domed and has a diameter that ranges from 6 mm to 20 mm and a radius of curvature that ranges from 15 mm to 300 mm.

14. The welding electrode set forth in claim 13, wherein the weld face includes a series of concentric circular ridges that project outwardly from a base surface of the weld face.

15. The welding electrode set forth in claim 10, wherein the first portion, the second portion, and the reduced diameter portion are integrally connected.

16. The welding electrode set forth in claim 10, wherein the first portion, the second portion, and the reduced diameter portion are constructed from a material having an electrical conductivity of at least 45% IACS and a thermal conductivity of at least 180 W/mK.

17. A method of resistance spot welding a workpiece stack-up that comprises an aluminum workpiece and a steel workpiece, the method comprising:
providing a workpiece stack-up that has a first side and a second side, the workpiece stack-up comprising an aluminum workpiece proximate the first side and an adjacent steel workpiece proximate the second side, the adjacent aluminum and steel workpieces overlapping each other such that a faying surface of the aluminum workpiece contacts a faying surface of the steel workpiece to establish a faying interface between the workpieces;
bringing a weld face of a first welding electrode into electrical communication with the first side of the workpiece stack-up, the first welding electrode comprising a first portion that includes the weld face, a second portion that defines an internal recess having a cooling pocket through which cooling fluid can flow, and a reduced diameter portion that extends between and connects a back surface of the first portion and a front surface of the second portion;
bringing a weld face of a second welding electrode into electrical communication with the second side of the workpiece stack-up, the weld faces of the first and second welding electrodes being facially aligned with each other at a weld site when the first and second welding electrodes are brought into electrical communication with their respective sides of the workpiece stack-up;
passing electrical current between the weld face of the first welding electrode and the weld face of the second welding electrode and through the workpiece stack-up at the weld site, the electrical current creating a molten aluminum weld pool within the aluminum workpiece that wets the faying surface of the adjacent steel workpiece; and
ceasing passage of the electrical current between the first and second welding electrodes to allow the molten aluminum weld pool to solidify into a weld joint that bonds the aluminum workpiece and the adjacent steel workpiece together at the weld site.

18. The method set forth in claim 17, wherein the workpiece stack-up includes only the aluminum workpiece and the steel workpiece at the weld site such that an exterior outer surface of the aluminum workpiece provides the first side of the workpiece stack-up and an exterior outer surface of the steel workpiece provides the second side of the workpiece stack-up.

19. The method set forth in claim 17, wherein the workpiece stack-up further comprises (1) an additional aluminum workpiece disposed adjacent to the aluminum workpiece such that an exterior outer surface of the additional aluminum workpiece provides the first side of the workpiece stack-up and an exterior outer surface of the steel workpiece provides the second side of the workpiece stack-up, or (2) an additional steel workpiece disposed adjacent to the steel workpiece such that an exterior outer surface of the aluminum workpiece provides the first side of the workpiece stack-up and an exterior outer surface of the additional steel workpiece provides the second side of the workpiece stack-up.

20. The method set forth in claim 17, wherein the first welding electrode is constructed such that the reduced diameter portion extends longitudinally between the back surface of the first portion and the front surface of the second portion along an axis of the weld face, and wherein peripheral edge sections of the back and front surfaces of the first and second portions define an annular gap that is vacant or filled with a low conductivity material having an electrical conductivity and a thermal conductivity that are less than an electrical conductivity and a thermal conductivity of each of the first portion, the second portion, and the reduced diameter portion.
